(19) United States
(12) Patent Application Publication
(10) Pub. No.: US 2014/0122369 A1
(43) Pub. Date: May 1, 2014

(54) PROOF SUPPORTED REVIEW SYSTEM

(71) Applicant: Edmond K. Chow, Hong Kong (HK)

(72) Inventor: Edmond K. Chow, Hong Kong (HK)

(21) Appl. No.: 13/850,295

(22) Filed: Mar. 25, 2013

Related U.S. Application Data
(60) Provisional application No. 61/615,274, filed on Mar. 24, 2012.

(51) Int. Cl. G06Q 30/02

(52) U.S. Cl. CPC G06Q 30/0282
USPC 705/347

(57) ABSTRACT

An invention is disclosed for an information system, method, or process that, among its enabling features, collects, organizes, and disseminates review information from customers with proof of involvement or engagement, such as sales receipts. Such a system, method, or process also provides a more inclusive, reliable, or otherwise effective way of gathering reviews for product, service, and seller and communicating them with consumers.

### CROSS REFERENCE TO RELATED APPLICATIONS

This application claims benefit under 35 U.S.C. §119(e) of provisional U.S. patent application No. 61/615,274, filed Mar. 24, 2012, the contents of which are incorporated herein by reference in their entirety.

### TECHNICAL FIELD

This invention relates to methods, processes, and systems for collecting, organizing, and disseminating consumer knowledge and information.

### BACKGROUND

In the era of the Internet, online reviews, including opinions, ratings and votes, are influential in determining the success of a product or seller. However, the current approaches to collecting such reviews cause scattering of knowledge for the same product or seller, or questionable reliability of the resulting data. For instance, some websites limit sources of reviews to well-known commentators, select reviewers, and people who have purchased the product from the websites. While this approach alleviates the potential inaccuracy of including reviews and ratings from people who may not have actually experienced or otherwise engaged with the product or seller, it excludes input from people who may have bought the product or interacted with the seller on another website, or at a brick-and-mortar store. Inevitably, if these people were to provide their opinions, they need to do so elsewhere thereby creating multiple destinations for reviews for the same product or seller. To be more inclusive, some other website, for example, allows any member to provide reviews against a product or seller. However, the readers of these reviews and ratings do not know if they came from a real customer or not. To achieve a compromise between such reliability and inclusivity, some websites allow reviews and ratings from non-customers, while providing an indicator to reviews associated with their customers. However, this approach could discriminate reviews from people who did purchase the product elsewhere. The present invention addresses these problems, and provides other benefits.

### SUMMARY

In accordance with one aspect of the invention, there is provided a method for collecting reviews with verifiable proof of engagement. The method involves receiving in a database from a user an indication of review information relative to a subject matter and an indication of a proof of engagement relative to the subject matter; storing in the database a review entry and a proof record, the review entry relative to the review information, and the proof record relative to the proof of engagement; associating in the database the proof record with the review entry; determining in the database that indications of other review entries associated with the subject matter exist; associating in the database the review entry with the subject matter; receiving from another user a request relative to the subject matter; and in response to the request, presenting to the other user an indication of feedback, the feedback based at least in part on the review entry and one or more of the other review entries. In one embodiment, the feedback presented to the other user includes an indication of the proof record associated with the review entry, or the availability of the proof record, where the other user may retrieve the proof record via the indication.

In accordance with another aspect of the invention, a system equipped with or embodying the present invention may calculate a score based on the review and one or more of the other reviews, and the user feedback may include the score. It may derive a score based on information available in the review entry and in one or more of the other review entries, includes assigning less or zero weight to any of the other review entries not being associated with a proof record.

In accordance with another aspect of the invention, a system equipped with or embodying the present invention may receive price information relative to the subject matter or engagement, and a code relative to the engagement, the code being unique to a seller for each instance of engagement with the seller. And the same code is available on the corresponding proof record for inspection. The method may further determine that the code associated with the seller does not exist, before associating in the database the proof record with the review entry.

In accordance with another aspect of the invention, a system equipped with or embodying the present invention may provide verification that a proof submission comprises information indicating engagement with the subject matter, the verification including, for example, checking via optical-character recognition or manual labor that the subject matter and engagement information (e.g., name of product, transaction time, seller information, payment amount) is present in the proof submission.

In accordance with another aspect of the invention, a system equipped with or embodying the present invention may receive specification or indications relative to a submission of a proof of engagement so that it may extract or obfuscate information available on the submission based on such specification or indications. The system may also receive a submission for a subject matter in relation to the review entry, so to create a new entry in the database for the subject matter, to or with which the review entry is applicable or may be associated.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 illustrates an example environment for collecting reviews from users;

FIG. 2 illustrates a block diagram of an example review system;

FIG. 3 illustrates a block diagram of an example proof server;

FIG. 4 illustrates a block diagram of a processor system implementing a review system comprising a proof server;

FIG. 5 illustrates an example presentation or screenshot of indications of reviews that may appear on a device coupled to a user, such as those coupled to the users as shown in FIG. 1;

FIG. 6 illustrates an example presentation or screenshot of a proof that may appear on a device coupled to a user, such as those coupled to the users as shown in FIG. 1; and

FIG. 7 illustrates a flow diagram of an example process for collecting reviews from users, such as those as shown in FIG. 1.

### DETAILED DESCRIPTION

A method, process, and system for collecting review information per some subject matter, such as that by consumers of products, sellers, offers, and events, are provided. Such review information includes any information expressing or comprising an opinion, and it includes but not limited to a vote, a selection of discrete choice(s) (e.g., like, dislike, OK), a numerical value, comments in text, audio or video, and so on. Example subject matters include a specific product, place, event, and so on, with which a consumer may engage or be involved. Review information may be associated with a proof record indicating previous engagement or relevant experience with the subject matter for which the review information is provided. A product may be a service, food and beverage, digital goods, or anything that may be owned, experienced, bought, auctioned, bartered, exchanged, or transferred. A place may be any provider of a product, including but not limited to a retail store, a wholesales, and a person. A subject matter may also be about an abstract entity. For example, a retail offer may be the subject matter of interest, and retail offer information may comprise product, seller, and price information. A retail offer description may also include time information, such as expiry time, transaction time, and/or submission time.

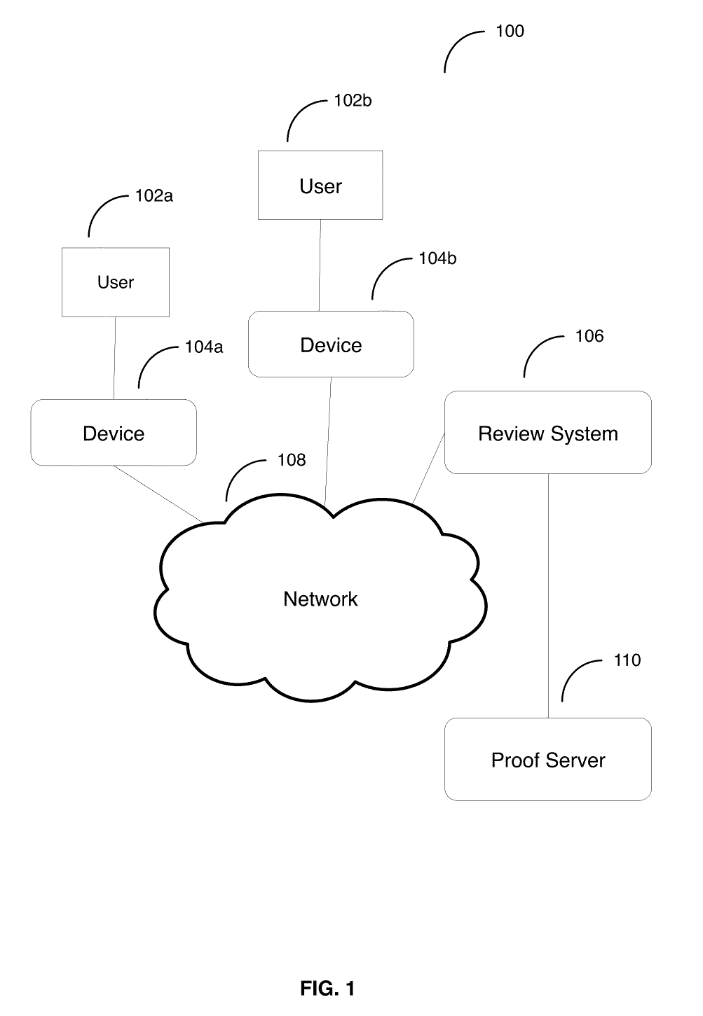

FIG. 1 illustrates an example environment 100 for collecting reviews of some subject matters from a user. A plurality of users 102a and 102b may submit and retrieve review information for a subject matter, such as a product, seller, offer, or event, at their respective devices 104a and 104b, which are communicatively coupled to a review system 106 via a network 108 such as the Internet. (And any type of network is within the scope of various embodiments.) The review system 106 may comprise any entity that receives, organizes, or publishes consumer reviews or their summaries pertaining to one or more subject matters, and include any system that accepts submissions of content or information comprising or indicating review content or information For example, the review system may include a search service that accepts queries or requests about a product or seller from one or more users through a device such as a computer, a terminal, or mobile phone, and presents the one or more users with consumer reviews or their summaries pertaining to the product, seller, sellers of the product, or the offers of the product or seller. The mode of such queries, requests or presentations may be textual, visual, audio, tactile, or anything communicable to or perceivable by the users. In addition, the review system 108 may act as a gateway or proxy to review information available at another review system (not shown), to which the review system may be coupled directly or via a network.

A proof server 110 is communicatively coupled to the review system 106. The proof server 110 maintains proof records in relation to the reviews that are available via the review system 106. According to one embodiment, an image of retail receipt may be a proof record, as well as an assertion by an authorized person such as a system administrator or an outsourced party that is tasked to verify a proof of engagement submission, or proof submission, submitted by a user. An example of a proof submission may include a retail sales receipt.

For instance, according to one embodiment, the user 102a may send a query via the device 104a about a retail item to a search engine comprised by or otherwise associated with the review system 106. In response the review system 106 retrieves review information associated with the retail item, the review information including the individual consumer reviews and a summary score based on the reviews, and presents the review information to the user 102a via the device 104a. Each review so presented includes an indication (e.g., an icon, a button, a hyperlinked text) that a copy of sales receipt is available for view. The user may select the indication so that in response the review system 106 may obtain from the proof server 110 the corresponding receipt image and presents the image to the user 102a via the device 104a.

According to another embodiment, a query about a retail item received by the review system 106 may cause the system 106 to return a list of sellers offering the retail item for sales, or a list of offers or advertisements relating to the retail item. Each entry in the list comprises an indication of consumer reviews, such as a review summary (e.g., a score based on the individual scores associated with the reviews). Such an indication is selectable so that its being selected by a user would cause the review system 106 to obtain a list of reviews relative to the seller, offer, or advertisement in question, where each review entry is associated with a user-selectable indication of the availability of proof of purchase, and the selection of this indication by a user causes the review system 106 to obtain an available representation of the proof from the proof server 110, and to present the representation to the user 102a via his coupled device 104a.

The user 102a may also select an existing entry of a subject matter as provided by the review system 106, or add a new entry for the subject matter to the review system 106, and then submit to the review system 106 a review (textual, audio, or otherwise) and a representation of proof of engagement (e.g. a photo of a sales receipt) in association with this entry. The review system 106 causes the proof server 110 to store as a proof record a representation of proof of engagement, and to maintain it for future retrieval. According to another embodiment, an administrator (not shown) may access the proof server 110 and select to accept or reject the proof submission comprising the proof of engagement or its representation.

The users 102a and 102b in FIG. 1 may submit reviews, receive reviews, or do both. They may be a machine or computer system acting in the role of a user. The users 102a and 102b may also be communicatively coupled to the review system 106 directly without via a network or a device. According to other embodiments, the review system 106 may comprise the proof server 110, or the proof server 110 may comprise a module or component associated with the review system 106.

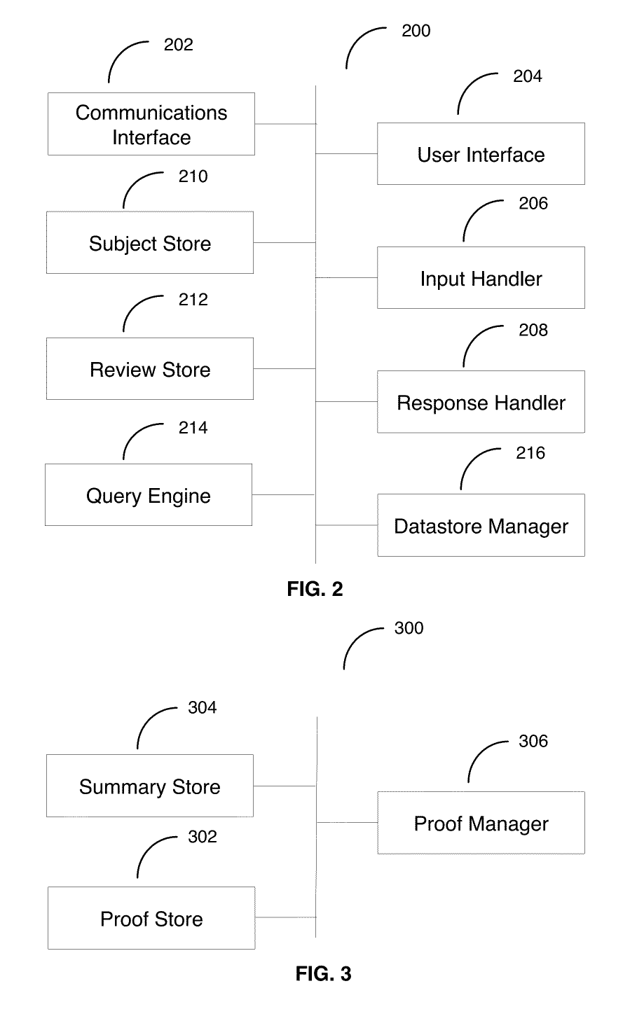

Referring to FIG. 2, a block diagram of an example review system 200, such as the review system 106 illustrated in FIG. 1, is shown. The example review system 200 includes a communications interface 202, a user interface 204, an input handler 206, a response handler 208, a subject store 210, a review store 212, a query engine 214, and a datastore manager 216.

The communications interface 202 is provided for communicating with devices over a communications medium, such as the devices 104a and 104b and the network 108 shown in FIG. 1. These devices communicate with the review system 200 via the communications interface 202 utilizing various modes of delivery of data or messages, such as requests, responses, and notifications. Examples of such requests include login credentials; submissions of subject matter information, reviews and representations of proof of engagement; queries for subject matters and reviews; requests for presentation of subject matters, reviews and proof records; and so on. Examples of such responses include search results or parts thereof, subject matter, review and proof information, references to subject matter, review and proof information, error messages, and so on. Examples of such notifications include asynchronously delivered subject matter, review and proof information, alerts of subject matter, review and proof information, location-triggered or time-of-day messages, and so on. Any type of communications interface or mode of delivery is within the scope of various embodiments.

The user interface 204 is provided for communicating with a user, such as via the devices 104a and 104b described herein. It is configured to interact with the user to obtain his input as well as presenting output to him. For instance, it may be configured to communicate with a display engine or graphical user interface included in the devices 104a and 104b that are coupled to the users 102a and 102b. It may also comprise a display engine or graphical user interface capable of accepting and presenting information from and to the users 102a and 102b, whether the information is graphical, textual, audio, or any other mode of communication. For example, the user interface 204 may present a search input box with which the user 102a types in their query, accept the query, and present information entries in response to the query. Data or messages between the user 102a and the user interface 204 are delivered via the communications interface 202. Any type of user interface is within the scope of various embodiments.

The input handler 206 is provided for processing requests and submissions. For instance, it interprets requests received by the user interface 204 from the user or the device, and directs or otherwise causes other components or modules in the review system to fulfill those requests. Examples of such requests include a query, new subject matter entry submission, review submission, proof submission, account login, and so on. For example, the input handler 206 may cause the datastore manager 218 to store reviews in the review store 212 in relation to a subject matter entry or entity maintained in the subject store 210. For a query request, the input handler 206 may cause the query engine 214 and response handler 208 to process the query and respond to the user or the device via the user interface 204. According to one embodiment, the input handler 206 may for some requests respond to the device or the user via the communications interface 202 or user interface 204. Examples of this type of requests include an information submission request, new user account request, and so on. The input handler may also generate inter-component or inter-module instructions based on or in response to incoming requests or submitted information.

The response handler 208 is provided for preparing data for delivery to the device via the communications interface 202 and for presentation to the user via the user interface. For instance, it may cause the query engine 214 to retrieve requested information (e.g., a list of offers for a product) as well as other relevant information (e.g., reviews for the product or each offer on the list) when it receives instructions from the input handler 206 to process a query. After receiving the results from the query engine 214, the response handler 208 may select an initial or partial set of the results and present to the user via the user interface 204 a response comprising this set. It may also include as part of the response a reference such as a URL with which the user may obtain another set of the results via the user interface 204. In some embodiments, the user interface 204 may cause the response handler 208 to process this request for the other set of results without involving the input handler 206. The response handler 208 may then cause the query engine 214 to retrieve the other set of results. According to other embodiments, the user interface 204 may cause the datastore manager 216 to retrieve the other set of results. The response handler 208 may also interact with a proof server such as the one (110) shown in FIG. 1 to retrieve additional information or references to additional information (such as proof records) and make them available as part of the response for delivery and presentation to the device and the user.

The subject store 210 is provided for storing information about subject matters of interest and their related data, including but not limited to their submission and publication timestamps, authorship, submitter identification, authorship or submitter privacy settings, and so on. The information and their related data may be stored, modified, added and so forth to any storage medium. Examples of timestamp include order of occurrence in a database, date, time of day, and the like. According to one embodiment, the subject store includes at least one index for the information entries available therein.

The review store 212 is provided for storing review information pertaining to subject matter entries maintained in or otherwise accessible via the subject store, as well as any associated metadata such as submission timestamps and submitter identities. It also maintains the association of review entries available therein with their corresponding subject matter entries. According to one embodiment, the review store 212 includes at least one index for the information entries available therein.

The datastore manager 216 is provided for maintaining, organizing and operating the subject store 210 and review store 212. Other modules or components communicate with the datastore manager 216 for access to the subject store 210 and review store 212. In one embodiment, other modules or components such as the query engine 214 may access directly the subject store 210 and review store 212 to obtain specific information entries or search their respective indexes. In some embodiments, the datastore manager 216 may include an indexing component or module that indexes the information entries or records available in the subject store 210 and review store 212 and facilitate fast retrieval for those information entries. It may maintain and store such indexes in a separate store (not shown).

The query engine 214 is provided for handling queries for subject matter information and related data or metadata. It may interpret or validate the queries and provide results to the queries as well as other data pertaining to the queries or results. For example, the query engine 214 may include in its response the size of the available results and the searching time associated with a query. It may communicate with the datastore manager 216 for access to the subject store 210 and review store 212 where the information entries and their related data or metadata are stored. In some embodiments, the query engine 214 may access the subject store 210 and review store 212 without involving the datastore manager 216 as an intermediary.

Although the review system 200 is described as being comprised of various components or modules (the communications interface 202, user interface 204, input handler 206, response handler 208, subject store 210, review store 212, query engine 214, and datastore manager 216), fewer or more components or modules may comprise the review system 200 and still fall within the scope of various embodiments. For example, the datastore manager 216 may comprise the query engine 214. The subject store 210 may comprise the review store 212. The input handler 206 may comprise the user interface 204, or the user interface 204 may be omitted (e.g., when the device provides the full user interface capability and communicates directly with the input handler 206). The input handler 206 may comprise the response handler 208. The response handler 208 may comprise the query engine 214 and datastore manager 216. The user interface 204 may comprise both the input handler 206 and response handler 208. And so on.

In one embodiment, the proof server 110 shown in FIG. 1 is configured to maintain and manipulate indications or representations of proof of engagement (e.g., an image of a sales receipt) associated with review entries maintained in a database (e.g., in the review store 212). The proof server 110 handles requests or instructions for accepting submissions of these indications or representations, and retrieving the same. For example, the proof server 110 may receive a retrieval request from the query engine 214 or response handler 206, and deliver indications of proof records (e.g., one or more indications or representations of proof of engagement) in response to the request. It may receive a proof submission request from the input handler 206, and create and maintain the association or relationship between the proof submission and its corresponding review entry in response to the request. It may also process the proof submissions to create proof records for suitable presentation, such as removing personal information for privacy purposes.

Referring to FIG. 3, a block diagram of an example proof server 300, such as the proof server 110 illustrated in FIG. 1, is shown. The example proof server 300 includes a proof store 302, a summary store 304, and a proof manager 306.

The proof store 302 is provided for storing information associated with proof records, such as indications or representations of proof of engagement associated with review entries in the review store 212. It may also store metadata associated with these proof records. In some embodiments, indications or representations of proof of engagement may be created or maintained outside of the proof store 302, the proof server 300 or the environment 100. For example, a third-party database (not shown) may be used to provide for these indications (e.g., URLs, Boolean assertions) or representations (e.g., digital photos, electronic documents) of proof of engagement. Alternatively, the proof store 302 may be located externally or remotely and accessed by the review system or the proof server over a network.

The summary store 304 is provided for storing summary information pertaining to reviews for which there exist proof records. Examples of such summary information includes a count of votes, a set of like/dislike counts, an average score of individual ratings, and so on.

The proof manager 306 is provided for maintaining, organizing and operating the summary store 304 and proof store 302. Other modules or components communicate with the proof manager 306 for access to these stores, such as retrieving a proof record. In one embodiment, the proof manager 306 may include an indexing component or module that indexes data available in the summary store 304 and proof store 302, and facilitate fast information retrieval for the data. It may maintain such indexes in their respective stores, and in another store (not shown). In some embodiments, the proof manager 306 is operably configured to cause the query engine 214 to search the summary store 304 and proof store 302.

Although the proof server 300 is described as being comprised of various components or modules (the summary store 304, proof store 302, and proof manager 306), fewer or more components or modules may comprise the review system and still fall within the scope of various embodiments. For example, the proof store 302 may comprise the summary store 304. Or the review system 106 may comprise the proof server 110 (e.g., the datastore manager 216 may comprise the proof manager 306 and the review store 212 may comprise the summary store 304 and proof store 302).

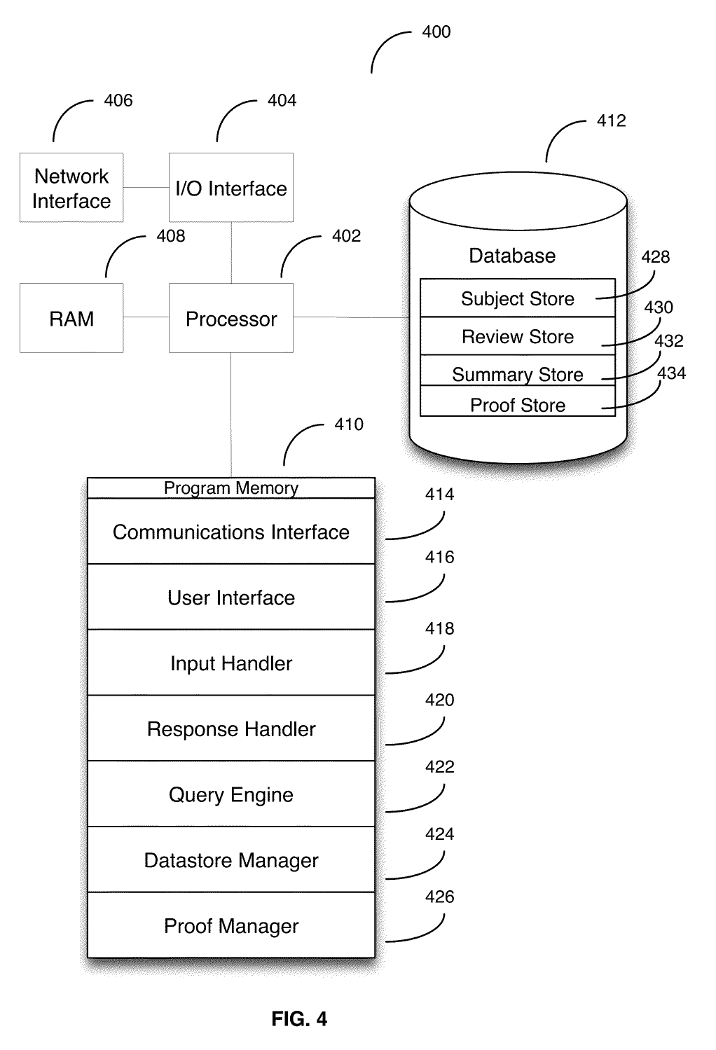

Referring to FIG. 4, a general block diagram of a processor system 400 implementing a review system comprising a proof server, such as the example review system 200 and the example proof server 300 illustrated in FIG. 2 and FIG. 3 respectively, is shown. Generally, in the embodiment shown, the processor system 400 includes a processor circuit comprising a processor 402, and an input/output (I/O) interface 404 to which a network interface 406 is coupled. The processor 402 is also in communication with random access memory (RAM) 408, program memory 410, and database memory 412. The processor 402 controls the database memory 412 under the direction of a general database manager, a specialized database manager, a combination thereof (herein referred to as a hybrid database manager), or a collection of database managers, implemented in codes stored in the program memory 410) that direct the processor 402 to perform database management functions to maintain one or more databases of data records in the database memory 412.

The term “processor system” has been used to indicate that the processor circuit shown in FIG. 4 is only one of a plurality of implementations and configurations and that, for example, the processor system 400 may employ a plurality of processors locally or geographically distributed to effect the functions described below that are performed by the processor system 400. The processor system 400 may be configured to contain fewer or more components. For example, the RAM 408 may comprise parts of or the entire database. Or the general database manager, the specialized database manager, the hybrid database manager, or the collection of database managers may include codes that direct the processor 402 to communication with a database located remotely from the review system. The remotely located database could be a commercial database, for instance, and the review system may merely be configured to interact with such database without requiring substantial memory or detailed database management functionality at the review system. A terminal interface (not shown) may be connected to the I/O interface 404 for direct interaction with users. Or the I/O interface may comprise the network interface 406. The processor system 400 may comprise a plurality of distributed processors, program memories, and databases coupled over a network. Or it may comprise a plurality of processor subsystems each capable of operating as a standalone processor system.

In one embodiment, to enable a review system (such as the one (106) shown in FIG. 1) to collect reviews and proof records from a user and to present their indications to another user, the program memory 410 may include the following components or modules: a communications interface 414 (such as the one (202) shown in FIG. 2, and being operably configured to perform its functionality as described above), a user interface 416 (such as the one (204) shown in FIG. 2, and being operably configured to perform its functionality as described above), an input handler 418 (such as the one (206) shown in FIG. 2, and being operably configured to perform its functionality as described above), a response handler 420 (such as the one (208) shown in FIG. 2, and being operably configured to perform its functionality as described above), a query engine 422 (such as the one (214) shown in FIG. 2, and being operably configured to perform its functionality as described above), a datastore manager 424 (such as the one (216) shown in FIG. 2, and being operably configured to perform its functionality as described above), and a proof manager 426 (such as the one (306) shown in FIG. 3, and being operably configured to perform its functionality as described above. The database 412 includes the following storages or repositories of data records or entries: subject store 428 (such as the subject store 210 shown in FIG. 2, and being operably configured to perform its functionality as described above), review store 430 (such as the review store 212 shown in FIG. 2, and being operably configured to perform its functionality as described above), summary store 432 (such as the summary store 304 shown in FIG. 3, and being operably configured to perform its functionality as described above), and proof store 434 (such as the proof store 302 shown in FIG. 3, and being operably configured to perform its functionality as described above).

For instance, in one embodiment, the communications interface 414 (e.g., HyperText Transport Protocol interface) is operably configured to direct a review system (such as the review system 106 shown in FIG. 1) to send and receive data and messages over a network via the I/O interface 404 (e.g., Transport Control Protocol port interface) coupled to the network interface 406 (e.g., Internet Protocol network interface). The user interface 416 is operably configured to cause the review system to accept requests and present responses and notifications from and to users via devices coupled to the users (such as the devices 104a and 104b and the users 102a and 102b shown in FIG. 1). The input handler 418 is operably configured to cause the review system to process and interpret requests such as a query for subject matter information, a request for submitting reviews, and a request for viewing proof records. The response handler 420 is operably configured to cause the review system to prepare results in response to user requests, and make them available to the users via the user interface 416. Such results include a review summary (e.g., a score), reviews or their excerpts and indications (e.g., URLs), and proof representations or their indications in response to a query from a user. The query engine 422 is operably configured to cause the review system to initiate a search of the subject store 428 and review store 430 for information entries that meets criteria set forth in user requests or requests from other components or modules. (In one embodiment, the query engine 422 is also operably configured to cause the review system to search the summary store 432 and proof store 434 in accordance with criteria set forth in user requests or requests from other components or modules.) The datastore manager 424 is operably configured to cause the review system to create and update data records in the subject store 428 and review store 430 for newly submitted information entries including subject matter entries (e.g., product, seller) and review entries. The proof manager 426 is operably configured to cause the review system to create and update data records in the summary store 432 and proof store 434. (In one embodiment, the datastore manager 424 may also be operably configured to cause the review system to create and update data records in the summary store 432 and proof store 434.)

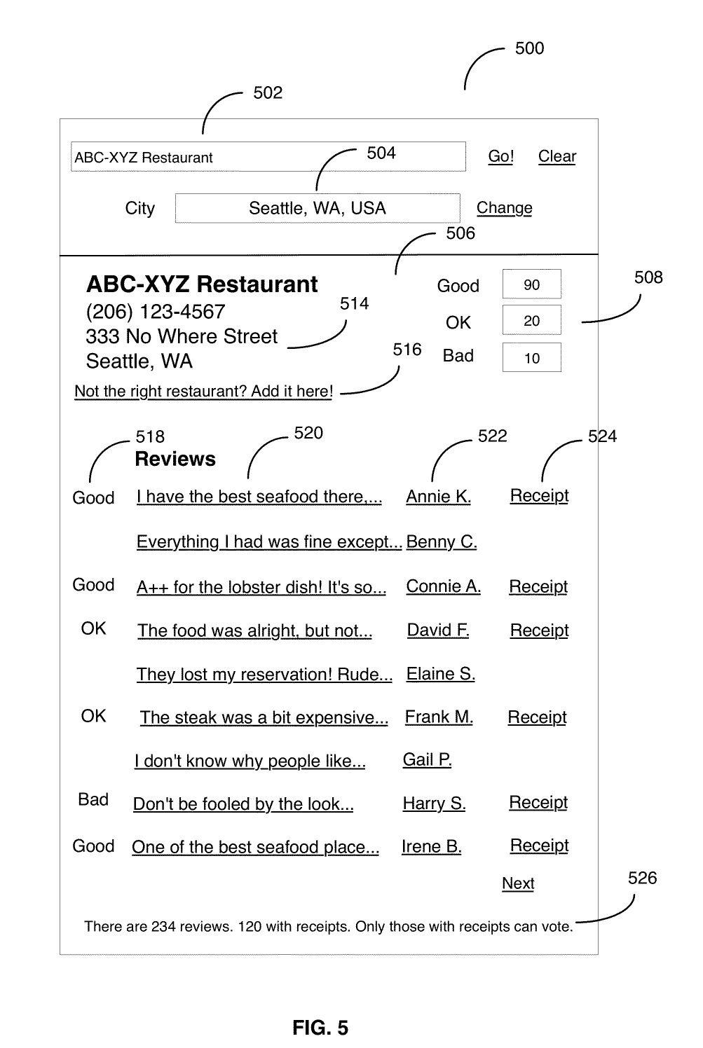

FIG. 5 is an example presentation or screenshot of a user interface display 500 that may appear on a device coupled to a user, such as the device 104a coupled to the user 102a shown in FIG. 1. At the top of the presentation 500 is an input area that comprises an input field 502 for description of subject matters (e.g., a restaurant) and a selection field 504 for city of interest (e.g., Seattle). This selection field 504 qualifies the geographical scope of the subject matter. Information in both fields constitutes as part of the query to be received and processed by the review system. (Any query criterion or mode of specification is within the scope of various embodiments.) Below them is query result area comprising information received from the review system. It includes the information 514 of a matching subject matter entry (e.g., ABC-XYZ Restaurant), along with a review summary 508 (e.g. 90 votes of good, 20 of OK, and 10 of bad), and a list of review entries, each review entry comprising a rating 518 (e.g., Good), a review excerpt 520 (e.g., “I have the best seafood there . . . ”), a reviewer identity 522 (e.g., Annie K.), and, if applicable, an indication 524 of the availability of a proof record (e.g., Receipt). The user may select the hyperlinked review excerpt 520, reviewer identity 522 and the indication 524 of proof to request further information regarding these entities respectively. The query result area also includes a hyperlinked message 516 that indicates and enables the user to add a new subject matter entry to the review system. And the particular embodiment shown in FIG. 5 does not accept or include ratings from reviews that do not have an associated proof record, as indicated by the hint text 526 at the bottom of the presentation.

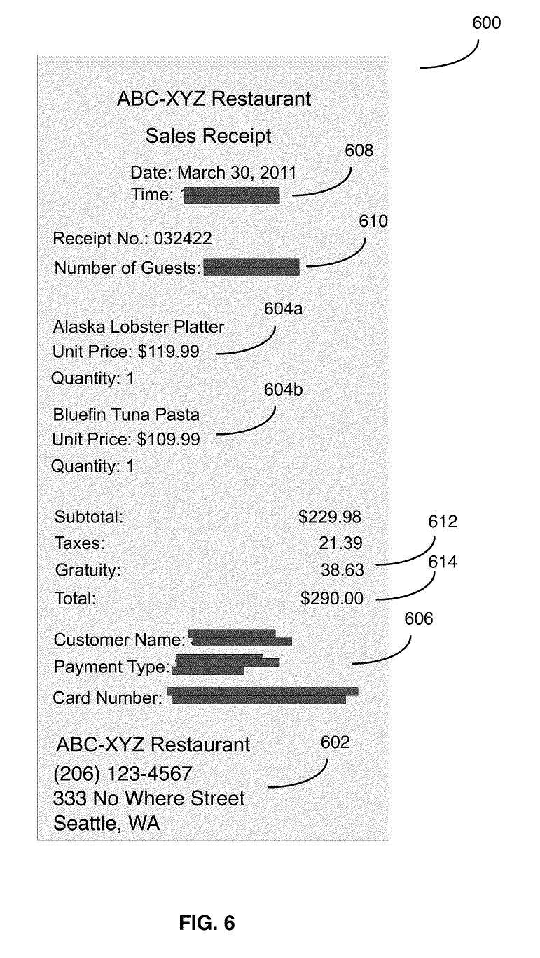

FIG. 6 is an example presentation or screenshot of a proof record 600 that may appear on a device coupled to a user, such as the device 104a coupled to the user 102a shown in FIG. 1. According to one embodiment, the review system receives a sales receipt from the device, and the input handler 418 of the review system may cause the proof manager 426 to detect information on the submitted receipt, digitally obfuscate or make it undecipherable in creating its corresponding record, and store the record in the proof store 434. Such detection may be performed based on recognition of key terms (such as payment, card number, customer name), or user assistance (such as coordinates or markers of areas of personal information accompanying the proof submission), or a combination thereof. A user may also submit a proof entry whose personal information has already been removed or made undecipherable. (All modes of detection and obfuscation are within the scope of various embodiments.) For instance, FIG. 6 shows the following information being obfuscated: transaction time 608, the number of guests 610, payment information 606 (i.e., customer name, payment type, and card number). While the gratuity 612 and total amounts 614 are shown, another user may indicate to the review system that those information fields should also be obfuscated. In an embodiment, the user may choose to obfuscate information that he deems irrelevant, such as information of other items on a sales receipt. An embodiment may also detect and extract subject matter information (e.g., seller information 602) on a proof submission and store it in the subject store 428.

According to one embodiment, the review system may search the subject store 428 for matching subject matters (e.g., product and/or seller) in response to proof submissions (e.g., a sales receipt). For instance, the review system may identify the seller of interest (e.g., ABC-XYZ Restaurant as in the seller information 602) as well as the products of interest (e.g., Alaska Lobster Platter 604a and Bluefin Tuna Pasta 604b), and prompt the user for review information, or other information relevant to the system, such as a proof submission, a photo of the product, revisions to the seller or product information, or information for a new seller or product. The review system may also create a new subject matter entry based entirely from a proof submission, such as a retail offer comprising information available on a sales receipt, including the product information, seller information, and price information.

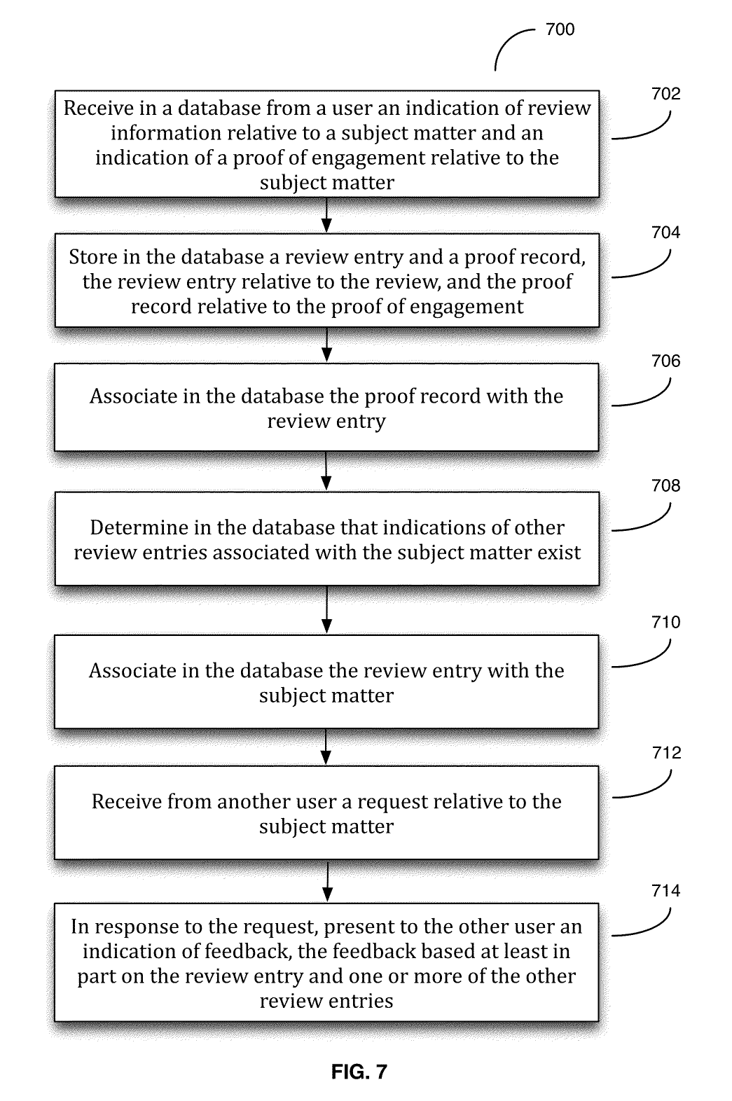

Referring to FIG. 7, a flow diagram of an example process 700 for collecting and publishing reviews and proof records is provided. Per the example process 700, an indication of review information relative to a subject matter and an indication of a proof of engagement relative to the subject matter are received in a database (702), such as the database 412 illustrated in FIG. 4. For example, the input handler of a review system such as the one (418) illustrated in FIG. 4 may receive from a device, such as the one (104a) shown in FIG. 1, an electronic submission of review text relative to a product that the review system has presented to the user of the device, as well as an electronic submission of a photo of a sales receipt for the product. In one embodiment, the receiving of the indication of the review and that of the indication of the proof of engagement may occur at a different time. The user of the device may also create a new entry of a product and submit it along with the review text and the sales receipt photo to the review system.

Per the example process 700, a review entry and a proof record, the review entry relative to the review information, and the proof record relative to the proof of engagement are stored in the database (704). For example, the input handler 418 may cause the datastore manager 424 of the review system to create a review entry based on the review submission, store the review entry in the review store 430, associate the review entry with its corresponding subject matter entry in the subject store 428 of the review system, and store this association in the review store 430 of the review system. The input handler 418 may also cause the proof manager 428 of the review system to create a proof record based on the sales receipt submission, and store the record in the proof store 434 of the review system. For example, such a proof record may be a digital representation of the sales receipt so submitted.

Per the example process 700, the proof record is associated with the review entry in the database (706). For instance, upon determining the time and submitter identity of the review submission and adding this information to the proof record, the proof manager 426 may associate the proof record with its corresponding review entry in the review store 430, and store this association in the proof store 434.

Per the example process 700, the existence of indications of other review entries associated with the subject matter is determined (708). For instance, the input handler 418 may determine if there exist in the review store 430 (e.g., directly, or via the datastore manager 424 or query engine 422) review entries for the product, service, seller or event relative to the newly created review entry.

Per the example process 700, the review entry is associated with the subject matter (710). For instance, the input handler 418 may cause the datastore manager 424 to associate the review entry with the other review entries or with an indication of the subject matter (e.g., an entry or record indicating the subject matter), and maintain this association in the review store 430. In one embodiment, such an association may be made via an entry or record relative to the subject matter, where the review entries maintain a reference to the entry or record. All modes and mechanisms of association in the database are within the various embodiments of the invention.

Per the example process 700, a request relative to the subject matter is received from another user (712). For instance, the input handler 418 may receive a request from another user, the request for getting seller information for a particular product.

Per the example process 700, in response to the request, the other user is presented with an indication of feedback, the feedback based at least in part on the review entry and one or more of the other review entries (714). For instance, the input handler 418 may cause the query engine 422 to locate an entry in the subject store 428, the entry matching the request relative to the subject matter (e.g., a particular product). The success of locating such an entry may cause the response handler 420 to retrieve via the datastore manager 424 relevant information in response to the request, the relevant information including review entries associated with the subject matter. In one embodiment, such relevant information includes indications of existence of proof records, whereby the other user may retrieve the proof records via these indications. In another embodiment, a summary score derived based on review entries having proof records may be provided.

It should be appreciated that the specific steps illustrated in FIG. 7 provide a particular method of collecting and disseminating review information and proof records according to an embodiment of the present invention. Other sequences of steps may also be performed according to alternative embodiments. For instance, alternative embodiments of the present invention may perform the steps outlined above in a different order. Moreover, the individual steps illustrated in FIG. 7 may include multiple sub-steps that may be performed in various sequences as appropriate to the individual step. Furthermore, additional steps may be added or removed depending on the particular applications and still fall within the scope of various embodiments. One of ordinary skill in the art would recognize many variations, modifications, and alternatives. For instance, in one embodiment, the step of associating in the database the review entry with the subject matter may be modified or otherwise implemented to associating in the database the review entry with other review entries for the subject matter, or with an entry or record relative to the subject matter. In another embodiment, the step of determining in the database that indications of other review entries associated with the subject matte exist may be omitted. In yet another embodiment, the feedback sent to the other user in response to his request may include only a review summary, or one review entry, even when there is more than one review entry available, for example, the entry with the latest review information or the most favorably voted entry. And the step of determining in the database that indications of other review entries associated with the subject matter exist may take place after the step of receiving from another user a request relative to the subject matter. In addition, a new step of checking if there are proof submissions or proofs referring to the same engagement instance may take place, for instance, if there is a unique code available on the proof submissions that may be utilized for such purposes. For example, a transaction code on a sales receipt which may be unique to a seller for a given period of time, may be used to identify duplicate proof submissions or records by recording and comparing the transaction code against the seller information and transaction date information pertaining to the subject matter.

Various embodiments of how the system or process can be employed for different review system applications have been provided. It will be appreciated that the system or process can be adapted to accommodate other applications of collecting and disseminating review information.

For instance, in one embodiment, a consumer providing submissions of review information and proof of engagement may replace or otherwise update a proof record in the review system. In another embodiment, users of the review system may vote or alert on the validity of proof records. For example, they may specifically indicate if certain information on a proof record is questionable, such as price, seller, date, or receipt information for the subject matter of a specific product whose acceptable proof of engagement is a sales receipt for the product. In another embodiment, a review summary instead of or in addition to individual review entries may be provided as feedback to a user request that triggers retrieval of review information for a subject matter. The determination of such a review summary may include taking an average of the total quantifiable reviews over the number of individual contributors or instances of contribution.

In another embodiment, the review system may accept entries comprising review information with or without corresponding proof submissions, while giving more weight to reviews therein having a proof submission or proof record. In yet another embodiment, the review system may accept and retain as proof record a reference (e.g., a uniform resource locator) or a machine-readable code via which other users or the review system may ascertain as proof of engagement for the subject matter in question. For example, a sales receipt for a product, seller, or event may be maintained at a third-party system (e.g., a file repository or server of a seller or a reviewer). A reference to the sales receipt or its representation may also be made available by the review system upon request. The review system may also contact a third-party system to verify any user-submitted information pertaining to the proof of engagement, the user-submitted information being made available by the review system also to the users of the system.

In one embodiment, the review system may enable a user to input, select, or otherwise identify information regarding the subject matter that can be verified on a proof submission, such as the price of a product, or a transaction code unique to the provider of a product for that particular transaction. The information so captured may be utilized to provide machine-implemented comparisons among review entries for the subject matter in question, and enable other users to verify the truthfulness or accuracy of such information, and report any discrepancies, thereby improving the transparency or accuracy of a proof-based open reviews collection process. In another embodiment, the review system may check the accuracy or validity of user-provided information against the proof submission without manual user intervention. The review system may also perform automatic or semi-automatic (i.e., partial assistance from submitters) information extract from proof submissions for a particular subject matter.

While the embodiment(s) described above may make reference to specific hardware and software components, methods, and structures, as well as organizations and arrangements thereof, those skilled in the art will appreciate that different modifications, adaptations, combinations, variations, and distributions of hardware components, software components, methods, and/or structures may also be used, and that particular operations described as being implemented in hardware might also be implemented in software or vice versa. All such modifications, adaptations, combinations, variations, and distributions that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiment(s) illustrated. For instance, method steps described herein may be performed in alternative orders or in parallel. Various embodiments of the invention include logic stored on non-transitory computer readable media, the logic configured to perform methods of the invention. The examples provided herein are exemplary and are not meant to be exclusive.

In addition, embodiments of the present invention may be realized using any combination of dedicated components and/or programmable processors and/or other programmable devices. Furthermore, computer programs incorporating various features of the present invention may be encoded on various non-transitory computer readable media for storage and/or communication; suitable media include magnetic disk or tape, optical storage media such as compact disk (CD) or DVD (digital versatile disk), flash memory, hard drive, and any other computer readable medium. Computer readable media encoded with the program code may be packaged with a compatible device or provided separately from other devices (e.g., via Internet download). Likewise, the invention, or certain aspects or portions thereof, may be embodied in propagated signals, or any other machine-readable communications medium. Where the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

Thus, although the invention has been described with respect to specific embodiments, it will be appreciated that the invention is intended to cover all modifications and equivalents within the scope of any relevant claims.

What is claimed is:

1. A computer-implemented method for collecting reviews, the method comprising, by a computer system:
receiving in a database from a user an indication of review information relative to a subject matter and an indication of a proof of engagement relative to the subject matter;
storing in the database a review entry and a proof record, the review entry relative to the review information, and the proof record relative to the proof of engagement;
associating in the database the proof record with the review entry;
determining in the database that indications of other review entries associated with the subject matter exist;
associating in the database the review entry with the subject matter;
receiving from another user a request relative to the subject matter; and
in response to the request, presenting to the other user an indication of feedback, the feedback based at least in part on the review entry and one or more of the other review entries.

2. The method of claim 1, wherein associating in the database the review entry with the subject matter includes deriving a score based on the review entry and one or more of the other review entries; and wherein the feedback includes the score.

3. The method of claim 2, wherein deriving a score based on the review entry and one or more of the other review entries includes assigning less or zero weight to any of the other review entries not being associated with a proof record.

4. The method of claim 1, wherein the subject matter includes a product, and the proof of engagement includes a purchase receipt of the product; and wherein associating in the database the review entry with the subject matter comprises associating in the database the review entry with a record identifying the product.

5. The method of claim 1, wherein the subject matter is a seller or event, and the proof of engagement is a purchase receipt from the seller or relative to the event; and wherein associating in the database the review entry with the subject matter comprises associating in the database the review entry with a record identifying the seller or event.

6. The method of claim 1, wherein the indication of the proof of engagement includes a digital copy of a transaction receipt, the receipt comprising information relative to the subject matter.

7. The method of claim 6, wherein the digital copy of the receipt includes an image, the image having a part concealed, or having an indication for a part whose information is to be obfuscated or extracted.

8. The method of claim 1, wherein receiving in the database from the user the indication of the review information relative to the subject matter and the indication of the proof of engagement relative to the subject matter includes receiving in the database from the user the indication of the review information relative to the subject matter, the indication of the proof of engagement relative to the subject matter, and price information relative to the subject matter or engagement.

9. The method of claim 1, wherein the proof of engagement includes a code, the code being unique to a seller for each instance of engagement with the seller; and wherein associating in the database the proof record with the review entry comprise associating in the database the proof record and the code with the review entry.

10. The method of claim 9, wherein receiving in the database from the user the indication of the review information relative to the subject matter and the indication of the proof of engagement relative to the subject matter includes receiving in the database from the user the indication of the review information relative to the subject matter, the indication of the proof of engagement relative to the subject matter, and the code.

11. The method of claim 10, further comprising:
before associating in the database the proof record with the review entry, determining in the database that the code associated with the seller does not exist.

12. The method of claim 1, wherein the feedback includes an indication of availability of the proof record being associated with the review entry.

13. The method of claim 12, further comprising:
In response to a request relative to the indication of availability of the proof record, presenting to the other user the proof record.

14. The method of claim 1, further comprising:
receiving a request from the user;
in response to the request relative to the subject matter, retrieving in the database one or more entries;
presenting the one or more entries to the user; and
wherein the indication of the review information relative to the subject matter includes an indication of review information relative to the one or more entries.

15. The method of claim 1, further comprising:
receiving a request from the user;
in response to the request relative to the subject matter, retrieving in the database one or more entries;
presenting the one or more entries to the user;
receiving an indication of another entry from the user; and
wherein the indication of the review information relative to the subject matter includes an indication of review information relative to the other entry, the other entry not being among the one or more entries.

16. The method of claim 1, further comprising determining that the proof record comprises information indicating engagement with the subject matter.

17. The method of claim 16, wherein determining that the proof record comprises information indicating engagement with the subject matter includes identifying subject matter information from the proof record and storing in the database the subject matter information.

18. The method of claim 17, wherein determining that the proof record comprises information indicating engagement with the subject matter includes determining by a third user that the proof record comprises information indicating engagement with the subject matter.

19. The method of claim 1, further comprises:
receiving a request from the user, the request relative to the proof record being associated with the review entry;
receiving from the user an indication of another proof of engagement; and
replacing in the database the proof record with another proof record based at least in part on the indication of the other proof of engagement.

20. The method of claim 19, further comprising:
wherein the feedback includes an indication of availability of the other proof record; and
in response to a request relative to the indication of availability of the other proof record, presenting the other proof record.
